(19) United States
(12) Patent Application Publication
(10) Pub. No.: US 2012/0235091 A1
(43) Pub. Date: Sep. 20, 2012

(54) POLARIZING FILM, COATING SOLUTION, AND IMAGE DISPLAY DEVICE

(75) Inventors: Sadahiro Nakanishi, Osaka (JP); Miyuki Kurogi, Osaka (JP); Hisae Shimizu, Osaka (JP); Satoru Suzuki, Osaka (JP)

(73) Assignee: NITTO DENKO CORPORATION, Osaka (JP)

(21) Appl. No.: 13/419,559

(22) Filed: Mar. 14, 2012

(30) Foreign Application Priority Data
Mar. 16, 2011 (JP) 2011-058154

(51) Int. Cl. C09K 19/32; C09B 56/12

(52) U.S. Cl. 252/299.62; 534/577

(57) ABSTRACT

The present invention provides a polarizing film having a high dichroic ratio.

The polarizing film of the present invention contains an azo compound represented by the following general formula (1).

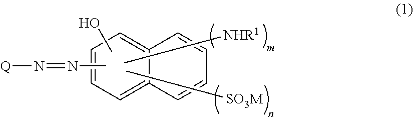

In the general formula (1), the OH group is attached to the naphthalene ring at an ortho position relative to the azo group attached to the ring, R¹ represents a hydrogen atom, a substituted or unsubstituted alkyl group, a substituted or unsubstituted acetyl group, a substituted or unsubstituted benzoyl group, or a substituted or unsubstituted phenyl group, M represents a counterion, m represents an integer of 0 to 2, n represents an integer of 0 to 6, at least one of m and n is not 0, and Q represents an anthraquinone ring having an OH group.

### TECHNICAL FIELD

The present invention relates to a polarizing film having a high dichroic ratio, and a coating solution for forming the polarizing film.

### BACKGROUND ART

The polarizing film is an optical member having a function of transpiring a specific linearly polarized light from a polarized light or natural light.

A general polarizing film is, for example, obtained by drawing a polyvinylalcohol film which is dyed with iodine.

There is also known a polarizing film which is obtained by a method (solution casting method) of coating a coating solution containing a lyotropic liquid crystalline compound onto a response surface.

For example, Patent Document 1 discloses a polarizing film obtained by coating a composition containing an anthraquinone-based compound and a solvent onto a substrate and drying the composition.

As such an anthraquinone-based compound, a compound is used in which an anthraquinone ring and a naphthalene ring having an OH group and the like are attached through an azo group (see the formulae (I-1 to 1-8, for example) in Patent Document 1).

Incidentally, in a market, a polarizing film having a high dichroic ratio is needed. However, a polarizing film having a high dichroic ratio cannot be obtained in the case where the above-mentioned anthraquinone-based compound disclosed in the Patent Document 1 is used.
Patent Document 1: Japanese Unexamined Patent Publication No. 2008-101154

### SUMMARY OF INVENTION

A first object of the present invention is to provide a polarizing film which contains an azo compound having an anthraquinone ring and has a high dichroic ratio.

A second object of the present invention is to provide a coating solution for forming a polarizing film having a high dichroic ratio.

A polarizing film of the present invention contains an azo compound represented by the following general formula (1).

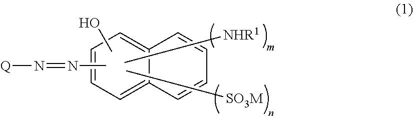

In the general formula (1), the OH group is attached to the naphthalene ring at an ortho position relative to the azo group attached to the ring, R¹ represents a hydrogen atom, a substituted or unsubstituted alkyl group, a substituted or unsubstituted acetyl group, a substituted or unsubstituted benzoyl group, or a substituted or unsubstituted phenyl group, M represents a counterion, m represents an integer of 0 to 2, n represents an integer of 0 to 6, at least one of m and n is not 0, and Q represents an anthraquinone ring represented by the following general formula (X), (Y) or (Z). In the formulae (X), (Y), and (Z), A represents a substituent, and a is a substitution number of A and represents an integer of 0 to 4.

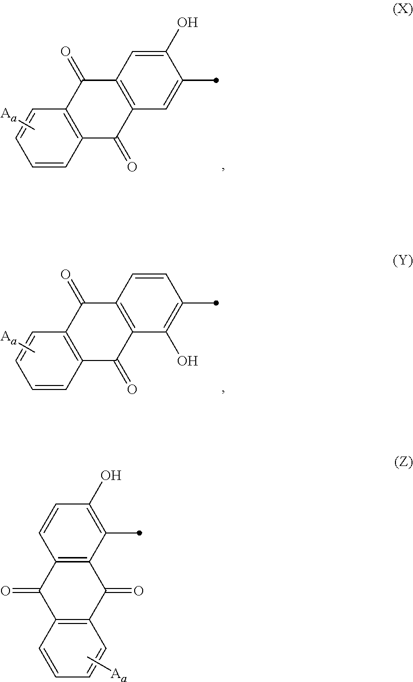

In a preferable polarizing film of the present invention, the azo compound is an azo compound represented by the following general formula (2).

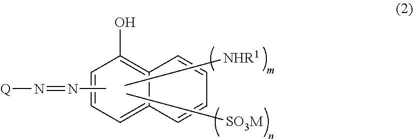

In the general formula (2), Q, R¹, M, m and n are the same as those in the general formula (1).

In other preferable polarizing film of the present invention, the azo compound is an azo compound represented by the following general formula (6), (7), or (8).

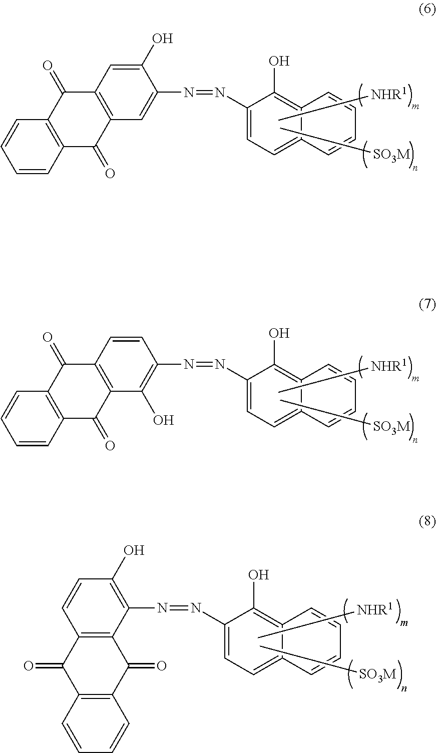

In the general formulae (6), (7), and (8), R¹, M, m and n are the same as those in the general formula (1).

In another aspect of the present invention, a coating solution is provided.

This coating solution contains the azo compound represented by the general formula (1) and a solvent.

In another aspect of the present invention, an image display device is provided.

This image display device contains any one of the polarizing films described above.

The polarizing film of the present invention has a high dichroic ratio since it contains an azo compound represented by the general formula (1).

The coating solution of the present invention contains an azo compound represented by the general formula (1). By coating the coating solution onto a suitable response surface, it is possible to obtain easily a polarizing film which is relatively thin and has a high dichroic ratio.

### BRIEF DESCRIPTION OF THE DRAWINGS

FIG. 1 is a partial sectional view showing a polarizing film according to one embodiment.

FIG. 2 is a partial sectional view showing a polarizing plate according to one embodiment.

### DESCRIPTION OF EMBODIMENTS

### Polarizing Film Containing azo Compound

The polarizing film of the present invention contains an azo compound represented by the following general formula (1).

The polarizing film of the present invention may contain one, or two or more azo compound(s) represented by the following general formula (1).

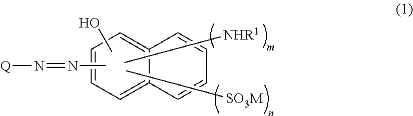

In the general formula (1), the OH group is attached to the naphthalene ring at an ortho position relative to the azo group attached to the ring, R¹ represents a hydrogen atom, a substituted or unsubstituted alkyl group, a substituted or unsubstituted acetyl group, a substituted or unsubstituted benzoyl group, or a substituted or unsubstituted phenyl group, M represents a counterion, m represents an integer of 0 to 2, n represents an integer of 0 to 6, at least one of m and n is not 0, and Q represents an anthraquinone ring represented by the following general formula (X), (Y) or (Z). In the general formulae (X), (Y), and (Z), A represents a substituent, and a is a substitution number of A and represents an integer of 0 to 4. When m is 2, each R¹ may be the same or different. When n is 2 or more, each M may be the same or different.

In the general formula (1), each substituent of NHR¹ and SO₃M may be substituted at any position on the naphthalene ring, respectively.

In the present specification, the wording “substituted or unsubstituted” means “having a substituent or having no substituent”.

Also, in the present specification, the wording “Y to Z” means “Y or more and Z or less”.

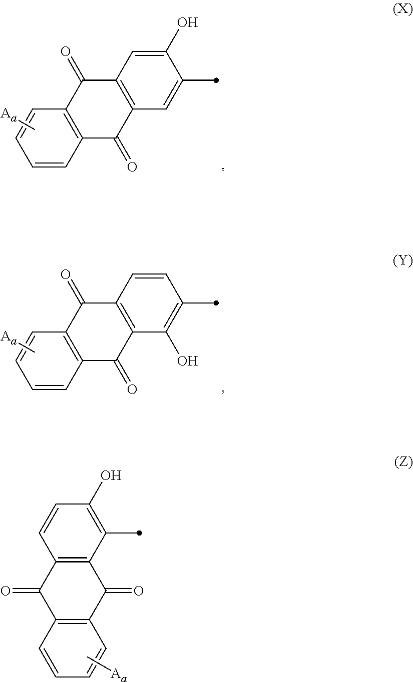

In the general formula (1), the OH group and the azo group (N of —N═N—) are attached to two adjacent carbon atoms in the naphthalene ring, respectively. Thus, the OH group and the azo group are attached in a relationship of an ortho position. Such an azo compound has a stable planar structure.

For example, when the azo group in the general formula (1) is attached at the 1-position to the naphthalene ring, the OH group may be attached at the 2-position, and when the azo group is attached at the 2-position to the naphthalene ring, the OH group may be attached at the 1-position or 3-position.

The azo compound in which the azo group is attached at the 2-position to the naphthalene ring and the OH group is attached at the 1-position, as represented by the following general formula (2), is preferably used. By using the azo compound represented by the general formula (2), a polarizing film having a particularly high dichroic ratio may be obtained. In the general formula (2), Q, R¹, M, m and n are the same as those in the general formula (1).

In the general formula (2), each substituent of NHR¹ and SO₃M may be substituted at any position on the naphthalene ring, respectively.

Herein, an azo compound in which the general formula (X), (Y) or (Z) is applied to Q in the general formula (2) is represented by the following general formula (3), (4) or (5).

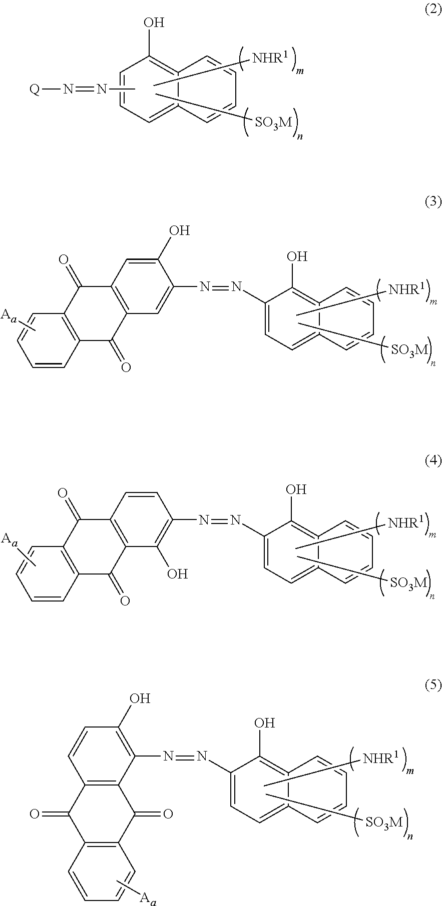

When an alkyl group, an acetyl group, a benzoyl group, or a phenyl group of R¹ in the general formula (1) has a substituent, the substituent may be the same substituent A as in the general formulae (X), (Y) and (Z). Specific examples of the substituent A are described below in detail.

The R¹ is preferably a hydrogen atom, a substituted or unsubstituted alkyl group, or a substituted or unsubstituted acetyl group, and more preferably a hydrogen atom or a substituted or unsubstituted acetyl group.

As the substituted or unsubstituted alkyl group, a substituted or unsubstituted alkyl group with a carbon number of 1 to 6 may be cited.

In the general formula (1), M (counter ion) is preferably a hydrogen ion; an alkali metal ion such as Li, Na, K, or Cs; an alkaline earth metal ion such as Ca, Sr, Ba; other metal ion; an ammonium ion which may be substituted by an alkyl group or an hydroxyalkyl group; a salt of an organic amine; and the like. As the other metal ion, Ni²⁺, Fe³⁺, Cu²⁺, Ag⁺, Zn²⁺, Al³⁺, Pd²⁺, Cd²⁺, Sn²⁺, Co²⁺, Mn²⁺, Ce³⁺, and the like may be cited as examples. As the organic amine, an alkylamine with a carbon number of 1 to 6, an alkylamine having a hydroxyl group with a carbon number of 1 to 6, an alkylamine having a carboxyl group with a carbon number of 1 to 6, and the like may be cited. When the compound represented by the general formula (1) has two or more SO₃M groups, each M may be the same or different. Also, when M of SO₃M is a cation having a valence of 2 or more in the general formula (1), the M is stabilized by an electrostatic bond with other anions, or by being shared by other azo compounds of the general formula (1).

In the general formula (1), m is preferably 1. In the general formula (1), n is preferably 1 or 2. Such an azo compound of the general formula (1) has an SO₃M group and an NHR¹¹ group, and therefore, is excellent in solubility in an aqueous solvent. Such an azo compound is preferable since it forms stable supramolecular aggregates in a solution and exhibits a liquid crystal phase.

As specific examples of the naphthalene ring of the general formula (1) which binds to the azo group, the following formulae (a) to (l) may be cited. R¹ and M in the general formulae (a) to (l) are the same as those in the general formula (1).

Among them, the azo compound of the general formula (1) having the formula (a) or the formula (b) can be synthesized from materials distributed in the market in large quantities. Accordingly, such an azo compound is preferable since it can be obtained at comparatively low cost.

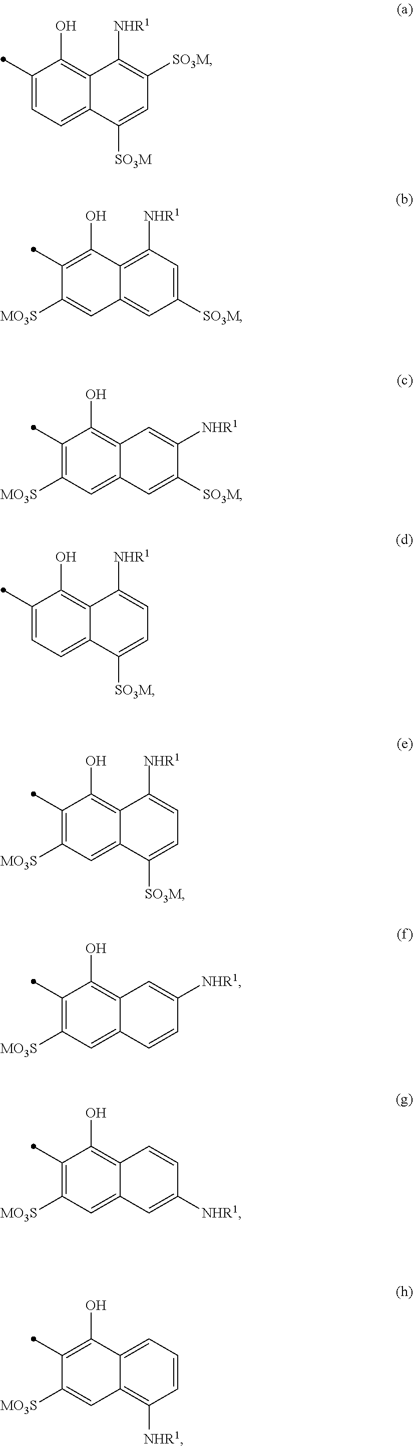

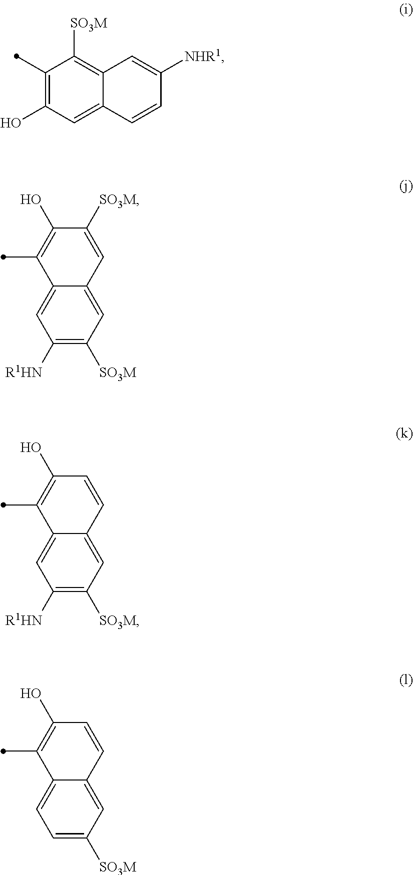

As the substituent A in the general formulae (X), (Y), and (Z), an alkyl group with a carbon number of 1 to 6, an alkoxy group with a carbon number of 1 to 6, a thioalkyl group with a carbon number of 1 to 6, a hydroxyalkyl group with a carbon number of 1 to 6 such as a dihydroxypropyl group, an alkylamino group with a carbon number of 1 to 6, a phenyl amino group with a carbon number of 6 to 20, an acyl amino group with a carbon number of 1 to 6, a halogeno group, a nitro group, a cyano group, an amino group, an acetamido group, an hydroxyl group, a sulfonic acid group such as a SO₃M group, a carboxyl group such as a COOM group, and the like may be cited as examples. When a plurality of the substituents A are present (when a is an integer of 2 or more), each substituent may be the same or different. A polarizing film containing an azo compound of the general formula (1) has a high dichroism regardless of whether the compound has such a substituent A on the anthraquinone ring or not.

Also, the substituent A preferably contains a polar group since an azo compound more excellent in water solubility may be obtained. The polar group means a functional group having polarity. Polar groups include functional groups containing oxygen and/or nitrogen which have comparatively large electronegativity, such as an OH group, a COOH group, an NH₂ group, an NO₂ group, and a CN group.

The substitution number a of the substituent is preferably 0 or 1. When the substitution number a is 0, the anthraquinone ring of the general formula (a) does not have a substituent A. That is, A is a hydrogen atom. Among azo compounds wherein the substitution number a is 0, a particularly preferable azo compound is represented by the following general formula (6), (7) or (8). In the general formulae (6), (7), and (8), R¹, M, m and n are the same as those in the general formula (1).

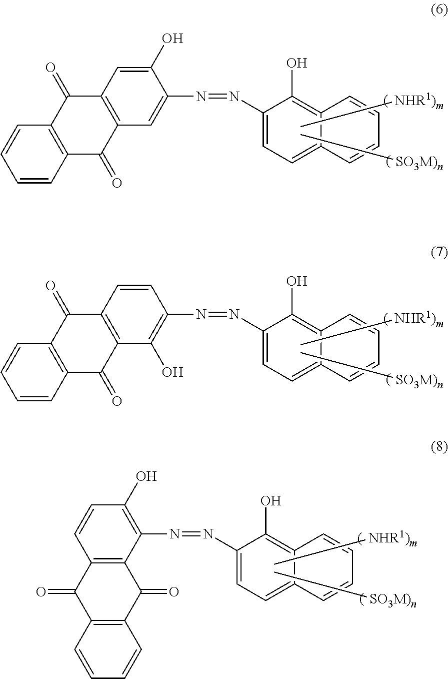

For example, the azo compound represented by the general formulae (1) to (8) may be synthesized in accordance with “Theoretic Manufacture, Dye Chemistry (Fifth Edition)” by Yutaka Hosoda (published by Gihodo, Jul. 15, 1968, pp. 135-152).

For example, azo compounds represented by the general formulae (1) to (8) may be obtained by converting an anthraquinone compound having an amino group and a hydroxyl group into a diazonium salt, and subjecting the salt to a coupling reaction with a hydroxynaphthalenesulfonic acid compound.

The polarizing film of the present invention has an absorption dichroism in at least part of wavelengths between 380 nm and 780 nm. The dichroic ratio of the polarizing film is preferably 10 or more, more preferably 14 or more, and particularly preferably 20 or more. The dichroic ratio can be determined by the method described in the following Examples. According to the present invention, it is also possible to provide a polarizing film having a dichroic ratio of 50 or more.

The degree of polarization of the polarizing film of the present invention is preferably 97% or more, more preferably 98% or more, and particularly preferably 99% or more. The degree of polarization can also be adjusted, for example, according to the thickness of a film. The transmittance (measured at a wavelength of 550 nm and 23° C.) of the polarizing film is preferably 35% or more and more preferably 40% or more. For example, the degree of polarization and the transmittance may be measured by a spectrometer (product name: “V-7100,” manufactured by JASCO Corporation).

The present inventors assume the reason that a polarizing film containing an azo compound represented by the general formula (1) has a high dichroism as follows.

In an azo compound of the general formula (1), OH groups are attached at an ortho position relative to positions to which an azo group is attached, in both naphthalene and anthraquinone rings in the azo compound. Since the OH groups have a high reactivity, a hydrogen atom of each OH group on naphthalene and anthraquinone rings binds to one nitrogen atom of an azo group, for example, in azo compounds of the general formulae (3) to (5), as shown in the following reference formulae (3-1) to (5-1), respectively.

Since such a change of each OH group of which a hydrogen atom binds to an azo group, a planar structure of both the naphthalene and anthraquinone rings is stabilized. Accordingly, a planar structure of the whole azo compound is stabilized. It is assumed that the stabilization of a planar structure has an effect of improving an absorption dichroism of an azo compound. Accordingly, a polarizing film containing an azo compound of the general formula (1) has a high dichroic ratio.

Herein, the reference formulae (3-1) to (5-1) correspond to azo compounds of the general formulae (3) to (5), respectively.

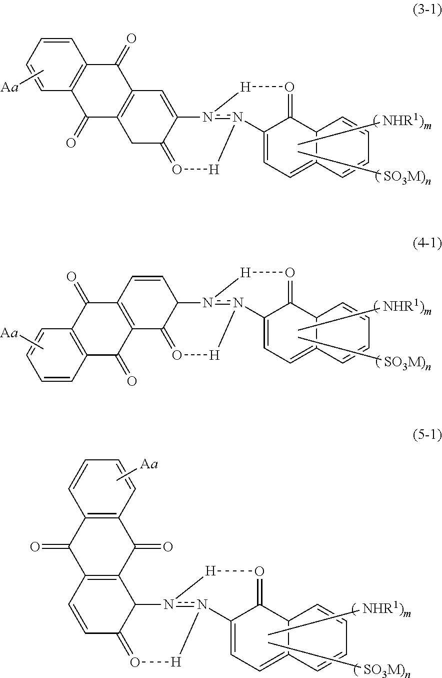

Also, the polarizing film of the present invention may contain other azo compounds, pigments other than azo compounds, and/or additives, in addition to an azo compound represented by the general formula (1). There is no particular limitation on the amount of these substances added, and the amount is, for example, more than 0% by mass and 50% by mass or less.

As the other azo compounds, the disazo compound represented by the following general formula (9) and the like may be cited.

Q¹−N═N−Q²−N═N−Q³ (9)

In the general formula (9), Q¹ and Q³ represent a substituted or unsubstituted aryl group, and Q² represents a substituted or unsubstituted arylene group.

When the aryl group and arylene group have a substituent, the substituent can be selected appropriately from those exemplified for the substituent A.

The Q¹ to Q³ each independently include a phenyl group, a condensed ring group in which two or more benzene rings are condensed such as a naphthyl group, and the other.

The Q¹ is preferably a substituted or unsubstituted phenyl group and more preferably a phenyl group having a polar group as a substituent. The Q³ is preferably a substituted or unsubstituted naphthyl group and more preferably a naphthyl group having a polar group as a substituent. As specific examples of the Q³, the formulae (a) to (l) and the like may be cited.

As the arylene group, a phenylene group, and a condensed ring group in which benzene rings are condensed such as a naphthylene group, and the other may be cited.

Q² in the formula (9) is preferably a substituted or unsubstituted naphthylene group, more preferably a naphthylene group having a polar group, and particularly preferably a 1,4-naphthylene group having a polar group.

As the other pigment, an anthraquinone-based compound, a perylene-based compound, a quinophthalone-based compound, a naphthoquinon-based compound, a merocyanine-based compound, and the like may be cited.

As the additive, a compatibility improving agent, a surfactant, a thermal stabilizer, an optical stabilizer, a lubricant, an antioxidant, a flame retardant, an antistatic agent, a polymer such as a polyvinylalcohol or a polyacrylamide, and the like may be cited.

### [Coating Solution of the Present Invention and Method for Producing a Polarizing Film Using the Same]

The polarizing film of the present invention can be obtained by coating a coating solution containing an azo compound represented by the general formula (1) and a solvent onto a suitable response surface in the form of a thin film, and then drying the coating film.

The polarizing film of the present invention can be produced preferably through the following step A and step B. As necessary, the following step C may be carried out after step B.

step A: a step of coating the solution, which contains the azo compound and the solvent, onto the response surface in order to form the coating film,

step B: a step of drying the coating film, and

step C: a step of subjecting a surface of the coating film dried in the step B to a water resistant treatment.

An alignment regulation force may be imparted to the response surface.

The coating solution of the present invention contains an azo compound represented by the general formula (1) and a solvent which dissolves or disperses the azo compound. There is no particular limitation on the azo compound to be used as long as it is represented by the general formula (1), and azo compound(s) represented by the general formula (1) may be used alone or in combination of two or more kinds.

The coating solution may be obtained by dissolving or dispersing the azo compound with a solvent such as an aqueous solvent and the like.

As necessary, in addition to the azo compound, other azo compound, a pigment, a polymer, and/or an additive may be added to the solvent.

The solvent is not particularly limited and a conventionally known solvent may be used; however, the solvent is preferably an aqueous solvent. As the aqueous solvent, water, a hydrophilic solvent, a mixed solvent containing water and the hydrophilic solvent, and the like may be cited. The hydrophilic solvent is a solvent, which can be dissolved with water almost uniformly. As the hydrophilic solvent, alcohols such as methanol and isopropyl alcohol; glycols such as ethylene glycol; cellosolves such as methyl cellosolve and ethyl cellosolve; ketones such as acetone and methyl ethyl ketone; esters such as acetic ether; and the like may be cited as examples. Preferably, the aqueous solvent is water or the mixed solvent containing water and the hydrophilic solvent.

The azo compound represented by the general formula (1) is excellent in solubility in the aqueous solvent since the compound has a polar group such as SO₃M group and the like.

The coating solution exhibits a liquid crystal phase by changing a temperature of the solution or a concentration of the azo compound in the solution.

The azo compound forms supermolecular aggregates in the coating solution, and as a result, the liquid crystal phase is caused. The type of the liquid crystal phase is not particularly limited, and a nematic liquid crystal phase, a smectic liquid crystal phase, a cholesteric liquid crystal phase, a hexagonal liquid crystal phase, and the like may be cited. The liquid crystal phase can be identified and confirmed from an optical pattern observed with a polarization microscope.

The concentration of the azo compound in the coating solution is preferably prepared so as to exhibit a liquid crystal phase. The concentration of the azo compound in the coating solution is 0.05% by mass to 50% by mass, preferably 0.5% by mass to 40% by mass, and more preferably 2% by mass to 30% by mass.

Also, a pH of the coating solution is prepared appropriately. The pH of the coating solution is preferably about pH 2 to pH 10 and more preferably about pH 6 to pH 8.

A temperature of the coating solution is preferably prepared 10° C. to 40° C. and more preferably 15° C. to 30° C.

The coating film is formed by coating the coating solution onto an appropriate response surface. The response surface is used for developing of the coating solution almost uniformly.

The response surface is not particularly limited as far as it is proper to the object. As the response surface, a surface of a polymer film, a surface of a glass plate, a surface of a metallic drum, and the like may be cited as examples. As the polymer film, an alignment film may be used. The alignment film has alignment regulation force on a surface thereof; therefore, the azo compound in the solution can certainly be aligned. The alignment film may be obtained by, for example, imparting the alignment regulation force to a film. As the method for imparting the alignment regulation force, a method of subjecting a surface of the film to rubbing treatment; a method of forming a coat of a polyimide and the like on the film, and then subjecting a surface of the coat to rubbing treatment; a method of forming a coat containing a compound that can undergo an optical reaction on the film, and then irradiating the coat with light, thereby forming the alignment film; and the like may be cited as examples.

As the response surface, a polymer film is preferably used and a polymer film excellent in transparency (for example, having a haze value of 3% or less) is preferably used.

As material of the polymer film, polyester-based polymers such as polyethylene terephthalate; cellulose-based polymers such as triacetylcellulose; polycarbonate-based polymers; acryl-based polymers such as polymethyl methacrylate; styrene-based polymers such as polystyrene; olefin-based polymers such as polypropylene and polyolefins having a cyclic or norbornene structure; and the like may be cited as examples. The norbornene-based polymer film is preferably used for aligning the azo compound excellently.

The coating method of the coating solution is not particularly limited, and for example, a coating method using a conventionally known coater may be adopted.

When a coating solution in such a state as to exhibit a liquid crystal phase is coated onto a response surface, shearing stress is applied to the supermolecular aggregates of the azo compound in a process where the coating solution flows. Therefore, long axis direction of the supermolecular aggregates becomes parallel to the flow direction of the coating solution, and a coating film in which supermolecular aggregates of the azo compound are aligned can be formed on the response surface.

As necessary, a magnetic field or an electrical field may be applied after the formation of the coating film so as to improve the alignment of the azo compound.

After the formation of the coating film by coating the coating solution, the workpiece is dried.

The drying may be natural drying, forcible drying, or the like. As the forcible drying, drying under reduced pressure, drying by heating, drying by heating under reduced pressure, and the like may be cited as examples.

The coating film will have a higher concentration in the drying process and, in accordance therewith, the azo compound will be aligned and will be fixed in that state. An absorption dichroism, which is a property of a polarizing film, is generated by fixing the alignment of the azo compound in the coating film. The obtained dried coating film can be used as a polarizing film.

As described above, the polarizing film of the present invention may be formed by solution casting method using the coating solution. Accordingly, by the present invention, a polarizing film having extremely thin thickness may be produced. The thickness of the polarizing film of the present invention is, for example, 0.1 μm to 10 μm and preferably 0.1 μm to 5 μm.

In order to impart water resistant property to a surface of the dried coating film, the following treatment may be subjected.

Concretely, the surface of the dried coating film is brought into contact with a solution containing at least one kind of a compound salt selected from the group consisting of aluminum salt, barium salt, lead salt, chromium salt, strontium salt, ceric salt, lanthanum salt, samarium salt, yttrium salt, copper salt, iron salt, and compound salts having two or more amino groups in a molecule.

By conducting this treatment, a layer containing the compound salt is formed on the surface of the dried coating film. The formation of this layer makes it possible to make the surface of the dried coating film insoluble in water or hardly soluble in water. Thus, water resistant property can be given to the dried coating film (polarizing film).

As necessary, the surface of the resultant polarizing film may be washed with water or a washing solution.

### [Usage and Others of Polarizing Film of the Present Invention]

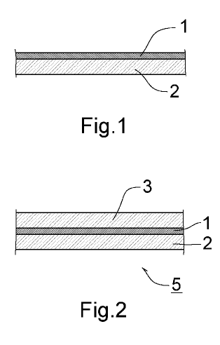

As illustrated in FIG. 1, a polarizing film 1 obtained by coating the coating solution onto a polymer film is laminated on the polymer film 2.

In general, the polarizing film 1 of the present invention is used in such a state as to be laminated on the polymer film 2. However, the polarizing film 1 can also be used separately from the polymer film 2.

The polarizing film 1 of the present invention may be further laminated other optical film. As the other optical film, a protective film, a retardation film, and the like may be cited as examples. A polarizing plate can be constituted by laminating a protective film and/or a retardation film on the polarizing film of the present invention.

FIG. 2 illustrates a polarizing plate 5 wherein a protective film 3 is laminated on a polarizing film 1 of the present invention. This polarizing plate 5 has a polymer film 2, the polarizing film 1 laminated on the polymer film 2, and a protective film 3 laminated on the polarizing film 1. The polymer film 2 has a function of protecting the polarizing film 1. Thus, in the polarizing plate 5, the protective film 3 is laminated on only one of the surfaces of the polarizing film 1.

Although not shown in the drawing, other optical films such as a retardation film and the like may be laminated on the polarizing plate 5.

In the case where the other optical film is laminated on the polarizing film, in practice, an appropriate adhesive layer is provided between these. As material for forming the adhesive layer, an adhesive agent, a pressure-sensitive adhesive agent, an anchor coating agent, and the like may be cited as examples.

The usage of the polarizing film of the present invention is not particularly limited. The polarizing film of the present invention is used as, for example, a constitution member of image display devices such as a liquid crystal display, an organic EL display, and the like.

In the case where the image display device is a liquid crystal display, preferable usage thereof is a television set, a portable telephone, a video camera, and the like.

### EXAMPLE

In the following, Examples and Comparative Examples are given in order to further describe the present invention. Here, the present invention is not limited only to the following Examples. The methods for analysis used in the Examples and Comparative Examples are as follows.

### [Method for Measuring Dichroic Ratio of Polarizing Film]

Using a spectrophotometer equipped with a Glan-Thompson polarizer (product name: “V-7100”, manufactured by JASCO Corp.), linearly-polarized measuring light was delivered on a polarizing film to be measured, and k1 and k2 of Y values luminosity-corrected were measured. The k1 and k2 were substituted into the following equation to obtain the dichroic ratio. Here, the k1 represents a transmittance of the linearly polarized light in the maximum transmittance direction of the polarizing film, and the k2 represents a transmittance of the linearly polarized light in the direction perpendicular to the maximum transmittance direction.

equation: dichroic ratio=log(1/k2)/log(1/k1)

### [Method for Observing Liquid Crystal Phase]

A small amount of a coating solution was sandwiched between two glass slides, and then the liquid crystal phase thereof was observed with a polarizing microscope (product name: “OPTIPHOT-POL”, manufactured by Olympus Corp.) equipped with a large-sized-sample heating and cooling, microscope-fittable stage (product name: “10013 L”, manufactured by Japan High Tech Co., Ltd.).

### [Method for Measuring Thickness of Polarizing Film]

The thickness of the polarizing film was measured as follows. A portion of the polarizing film formed on a norbornene-based polymer film was peeled off and a step between the polymer film and the polarizing film was measured by using a three-dimensional non-contact surface form measuring system (product name: “Micromap MM5200,” manufactured by Ryoka Systems Inc.).

### Synthesis Example 1 of azo Compound

To 2-amino-3-hydroxyanthraquinone (1 g, 3.58 mmol) charged into a vessel, dimethylsulfoxide (30 mL) and hydrochloric acid (0.75 g, 8.96 mmol) were added to dissolve the material. To the solution on an ice bath, lithium nitrite (0.25 g, 3.58 mmol) dissolved in water was added. Subsequently, the solution was stirred for 1 hour, and an aqueous sulfamic acid solution was then added to the solution in a suitable amount. In this manner, a suspension of a diazonium salt was obtained.

Sodium 1-amino-8-hydroxy-2,4-naphthalenedisulfonate hydrate (1.16 g, 3.40 mmol) and water (100 mL) were charged into another vessel, to which an aqueous lithium hydroxide solution was added, and the pH of the mixture was adjusted to 10. The solution was retained at 5° C. or less on an ice bath, and the suspension of a diazonium salt was added to the solution to carry out a coupling reaction. During the reaction, the pH of the mixture was adjusted to 9.5 to 10 using an aqueous lithium hydroxide solution. After the total amount of the suspension of a diazonium salt was added, the ice bath was removed, and the mixture was stirred at room temperature for further 1 hour. After confirming the completion of the reaction by TLC, the pH of the reaction solution was neutralized using hydrochloric acid. Furthermore, water was distilled off from the reaction solution, and the resulting product was washed with acetone, filtrated, purified using a column, and dried to obtain an azo compound of the following formula (11) (0.31 g, 0.55 mmol, 15%).

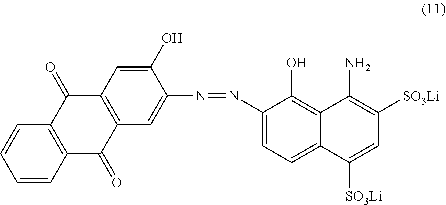

### Synthesis Example 2 of azo Compound

An azo compound of the following formula (12) was obtained in the same way as in synthesis example 1 except that sodium 1-amino-8-hydroxy-2,4-naphthalenedisulfonate hydrate was changed to sodium 1-amino-8-hydroxy-3,6-naphthalenedisulfonate hydrate.

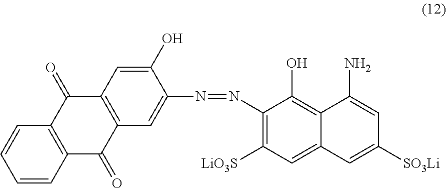

### Synthesis Example 3 of azo Compound

An azo compound of the following formula (13) was obtained in the same way as in synthesis example 1 except that sodium 1-amino-8-hydroxy-2,4-naphthalenedisulfonate hydrate was changed to sodium 1-acetylamino-8-hydroxy-2,4-naphthalenedisulfonate hydrate.

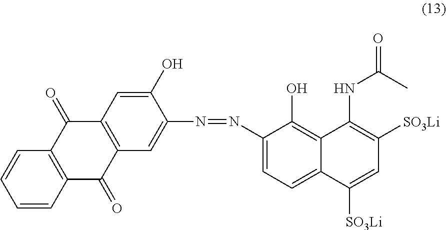

### Synthesis Example 4 of azo Compound

An azo compound of the following formula (14) was obtained in the same way as in synthesis example 1 except that 2-amino-3-hydroxyanthraquinone was changed to 2-aminoanthraquinone.

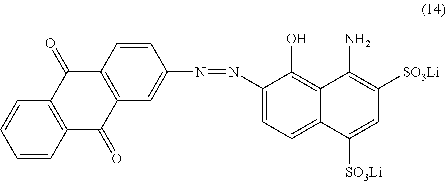

### Synthesis Example 5 of azo Compound

An azo compound of the following formula (15) was obtained in the same way as in synthesis example 1 except that 2-amino-3-hydroxyanthraquinone was changed to 2-aminoanthraquinone, and sodium 1-amino-8-hydroxy-2,4-naphthalenedisulfonate hydrate was changed to sodium 1-amino-8-hydroxy-3,6-naphthalenedisulfonate hydrate.

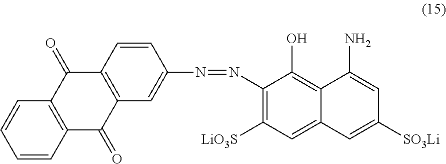

An azo compound of the following formula (16) was obtained in the same way as in synthesis example 1 except that 2-amino-3-hydroxyanthraquinone was changed to 2-aminoanthraquinone, and sodium 1-amino-8-hydroxy-2,4-naphthalenedisulfonate hydrate was changed to sodium 1-acetylamino-8-hydroxy-2,4-naphthalenedisulfonate hydrate.

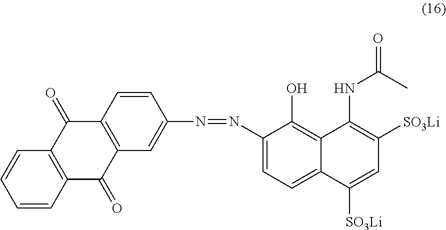

### Example 1

The azo compound of the formula (11) was dissolved into ion exchanged water to prepare a 5% by mass of coating solution.

The coating solution was coated on a norbornene-based polymer film (trade name: “ZEONOR” manufactured by Zeon Corporation) subjected to rubbing treatment and corona treatment by using a bar coater (product name: “Mayer rot HS4”, manufactured by Bushman Co.). After that, the workpiece was naturally dried. The dried coating film was a polarizing film.

The thickness of the polarizing film was about 0.2 μm. The measured result of a dichroic ratio of the polarizing film is shown in Table 1.

Incidentally, the solution having a concentration of 20% by mass was prepared separately by dissolving the azo compound of formula (11) into ion exchanged water. The solution exhibited a nematic liquid crystal phase when it was observed in accordance with the above-mentioned method for observing liquid crystal phase at 23° C.

### Example 2

A polarizing film having a thickness of about 0.2 μm was produced in the same way as in Example 1 except that the azo compound of the formula (11) was changed to the azo compound of the formula (12). The measured result of a dichroic ratio of the polarizing film is shown in Table 1.

### Example 3

A polarizing film having a thickness of about 0.2 μm was produced in the same way as in Example 1 except that the azo compound of the formula (11) was changed to the azo compound of the formula (13). The measured result of a dichroic ratio of the polarizing film is shown in Table 1.

### Comparative Example 1

A polarizing film having a thickness of about 0.2 μm was produced in the same way as in Example 1 except that the azo compound of the formula (11) was changed to the azo compound of the formula (14). The measured result of a dichroic ratio of the polarizing film is shown in Table 1.

### Comparative Example 2

A polarizing film having a thickness of about 0.2 nm was produced in the same way as in Example 1 except that the azo compound of the formula (11) was changed to the azo compound of the formula (15). The measured result of a dichroic ratio of the polarizing film is shown in Table 1.

### Comparative Example 3

A polarizing film having a thickness of about 0.2 nm was produced in the same way as in Example 1 except that the azo compound of the formula (11) was changed to the azo compound of the formula (16). The measured result of a dichroic ratio of the polarizing film is shown in Table 1.

TABLE 1

| | azo compound | dichroic ratio |
|---|---|---|
| Example 1 | formula (11) | 55.6 |
| Example 2 | formula (12) | 14.5 |
| Example 3 | formula (13) | 21.0 |
| Comparative Example 1 | formula (14) | 30.3 |
| Comparative Example 2 | formula (15) | 6.7 |
| Comparative Example 3 | formula (16) | 6.4 |

### Evaluation

Azo compounds of the formulae (11) to (13) are azo compounds in which an azo group and an OH group are attached at an ortho position in an anthraquinone ring. On the other hand, azo compounds of the formulae (14) to (16) do not have an OH group in an anthraquinone ring.

The polarizing films of Examples 1 to 3 using azo compounds in which an azo group and an OH group are adjacently attached in a naphthalene ring and an anthraquinone ring had an extremely high dichroic ratio as compared with polarizing films of Comparative Examples 1 to 3.

From these results too, it is evident that use of an azo compound in which an azo group and an OH group are attached at an ortho position in an anthraquinone ring allows the formation of a polarizing film having a high dichroic ratio.

### INDUSTRIAL APPLICABILITY

The polarizing film of the present invention may be used as, for example, a constitution member of liquid crystal display devices, polarized sunglasses, and the like.

The coating solution of the present invention may be used as a forming material of polarizing films.

### REFERENCE SIGNS LIST

1 polarizing film
2 substrate
3 protective film
5 polarizing plate

What is claimed is:

1. A polarizing film comprising an azo compound represented by the following general formula (1): 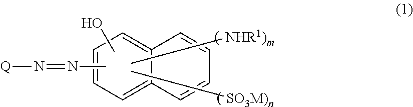
wherein the OH group is attached to the naphthalene ring at an ortho position relative to the azo group attached to the ring, R¹ represents a hydrogen atom, a substituted or unsubstituted alkyl group, a substituted or unsubstituted acetyl group, a substituted or unsubstituted benzoyl group, or a substituted or unsubstituted phenyl group, M represents a counterion, m represents an integer of 0 to 2, n represents an integer of 0 to 6, at least one of m and n is not 0, Q represents an anthraquinone ring represented by the following general formula (X), (Y) or (Z), A represents a substituent, and a is a substitution number of A and represents an integer of 0 to 4.

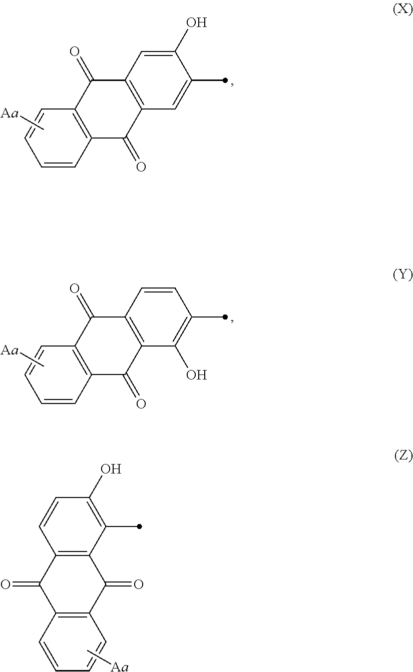

2. The polarizing film according to claim 1, wherein the azo compound is an azo compound represented by the following general formula (2): 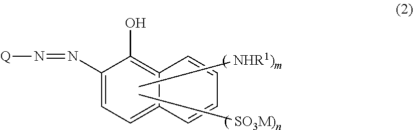
wherein in the general formula (2), Q, R¹, M, m and n are the same as those in the general formula (1).

3. The polarizing film according to claim 1, wherein the azo compound is an azo compound represented by the following general formula (6), (7), or (8): 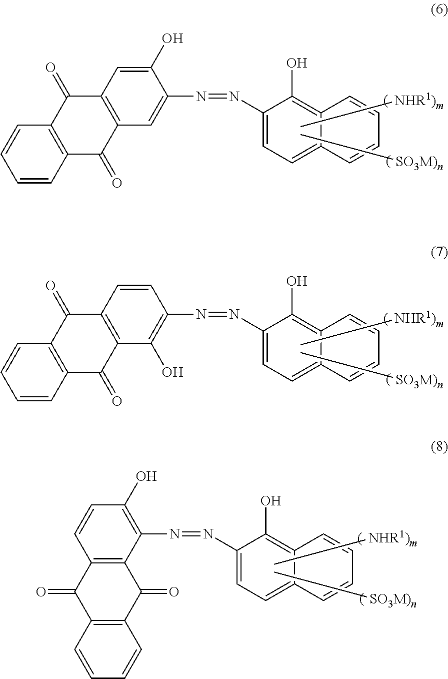
wherein in the general formulae (6), (7), and (8), R¹, M, m and n are the same as those in the general formula (1).

4. A coating solution comprising an azo compound represented by the following general formula (1) and a solvent: 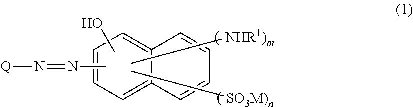
wherein the OH group is attached to the naphthalene ring at an ortho position relative to the azo group attached to the ring, R¹ represents a hydrogen atom, a substituted or unsubstituted alkyl group, a substituted or unsubstituted acetyl group, a substituted or unsubstituted benzoyl group, or a substituted or unsubstituted phenyl group, M represents a counterion, m represents an integer of 0 to 2, n represents an integer of 0 to 6, at least one of m and n is not 0, Q represents an anthraquinone ring represented by the following general formula (X), (Y) or (Z), A represents a substituent, and a is a substitution number of A and represents an integer of 0 to 4.

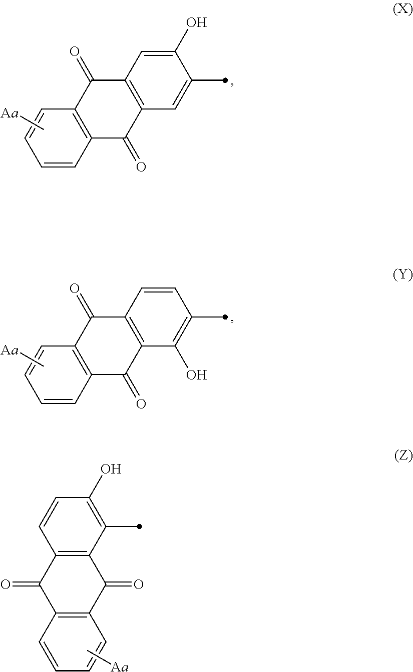

5. An image display device comprising the polarizing film according to claim 1.
